(19) United States
(12) Patent Application Publication
(10) Pub. No.: US 2006/0218180 A1
(43) Pub. Date: Sep. 28, 2006

(54) Content directory service import container

(75) Inventors: Maarten Peter Bodlaender, Eindhoven (NL); Jozef Pieter Van Gassel, Eindhoven (NL); Erik Peter Maria Niessen, Eindhoven (NL); Jennifer J. M. M Blijlevens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILLIPS ELECTRONICS N.V.

(21) Appl. No.: 10/552,080

(22) PCT Filed: Mar. 30, 2004
(86) PCT No.: PCT/IB04/50364

§ 371 Date: Oct. 4, 2005

(30) Foreign Application Priority Data
Apr. 7, 2003 (EP) 03100911.1

(51) Int. Cl. G06F 7/00

(52) U.S. Cl. 707/103 R

(57) ABSTRACT

A system 100 includes a plurality of devices 150, 160, 162, 164, 166 that can communicate via a network (110). The server device 150 includes a content directory service (hereinafter “CDS”) with a dynamic, hierarchical structure of containers, each capable of storing objects; each object including an object description and an object content or object content locator, such as a URL. The CDS includes a predetermined upload container. The other devices in the system can make an object available via the CDS to devices in the system by uploading the object to the predetermined container. The server determines for an uploaded object a container in the CDS based on the object description and/or object content, and moves the uploaded object to the determined container.

### FIELD OF THE INVENTION

The invention relates to a digital storage device including a content directory service (hereinafter “CDS”) with a dynamic, hierarchical structure of digital storage containers, each capable of storing digital data objects; each object including an object description and an object content or object content locator, such as a URL. The invention further relates to a system including a plurality of devices operative to communicate via a network; at least one of the devices (hereinafter “server”) including a CDS. The invention further relates to a method of assigning a digital data object to a digital storage container in a CDS and to a computer program for performing such a method.

### BACKGROUND OF THE INVENTION

Storage capacity has increased significantly. By now, hard disks have a capacity to store a huge amount of ordinary files, such as word processing files, as well as multi-media content. Similarly, high-capacity recordable optical storage is becoming available, for example, in the form of DVD+RW and DVR. Multi-media content is expected to be a main source for storage. Such content may include pre-recorded audio (e.g. in the form of audio CDs, or MP3 encoded tracks), pre-recorded video (e.g. DVDs), digital video home recordings, broadcast digital audio (e.g. Internet radio), broadcast digital video, digital photos, etc. It is desired to store such digital content in a structured manner to enable simple and fast retrieval. In particular for personal computers various solutions are available. For example, the Microsoft Media Player and the Real Media player provide an interface for hierarchical, structured storage of audio and video titles. After activating the program, the user can browse through the structure, change the structure and add content in a user-selectable location in the structure. The above mentioned programs are intended for use within one computer.

For operations in a networked system the Content Directory Service within the Universal Plug and Play (UPnP) architecture is known. The current publicly available version of UPnP is Version 1.0 of 8 Jun., 2000. UPnP is a distributed, open networking architecture based on TCP/IP and Web technologies to enable seamless proximity networking in addition to control and data transfer among networked devices in the home, office, and public spaces. In addition to being an extension of the plug and play peripheral model, UPnP is designed to support zero-configuration, “invisible” networking, and automatic discovery for a breadth of device categories from a wide range of vendors. This means a device can dynamically join a network, obtain an IP address, convey its capabilities, and learn about the presence and capabilities of other devices. A device can leave a network smoothly and automatically without leaving any unwanted state behind. IP internetworking spans different physical media, enables multiple-vendor interoperation, and achieves synergy with the Internet and many home and office intranets. Via bridging, UPnP accommodates media running non-IP protocols.

UPnP makes a distinction between control points and controlled devices. A device capable of controlling one or more devices is referred to as a control point. Controlled devices offer services to the network, control points use offered services (thus controlling a controlled device). Control points and controlled devices are logical entities: a physical device can host any combination of (multiple) control points and (multiple) controlled devices that offer a variety of services.

Many devices within a UPnP compliant network, such as a UPnP home network, contain various types of content that other devices in the network would like to access (e.g. music, videos, still images, etc). As an example, a “Media Server” device might contain audio, video, and still-image libraries. In order for the user to enjoy this content, the user must be able to browse the objects stored on the Media Server, select a specific one, and cause it to be “played” on an appropriate rendering device (e.g. an audio player for music objects, a TV for video content, an Electronic Picture Frame for still-images, etc). For maximum convenience, it is highly desirable to allow the homeowner to initiate these operations from a variety of user interface (UI) devices. In most cases, these UI devices will either be a UI built into the rendering device, or it will be a stand-alone UI device such as a wireless PDA or tablet. It is desired that a user can access the content without having to interact directly with the device containing the content. In order to enable this capability, the service device needs to provide a uniform mechanism for UI devices to browse the content on the server and to obtain detailed information about individual content objects. To this end the UPnP architecture has defined the Content Directory Service (CDS). The current publicly available description of CDS is the “Content Directory Service Template Version 1.01” for Universal Plug and Play Version 1.0, dated Jun. 25, 2002. The Content Directory Service additionally provides a lookup/storage service that allows clients (e.g. UI devices) to locate (and possibly store) individual objects (e.g. songs, movies, pictures, etc) that the (server) device is capable of providing. For example, this service can be used to enumerate a list of songs stored on an MP3 player, a list of still-images comprising various slide-shows, a list of movies stored in a DVD Jukebox, a list of TV shows currently being broadcast (e.g. an EPG), a list of songs stored in a CD Jukebox, a list of programs stored on a PVR (Personal Video Recorder) device, etc. Nearly any type of content can be enumerated via this Content Directory Service. For those devices that contain multiple types of content (e.g. MP3, MPEG2, JPEG, etc), a single instance of the Content Directory Service can be used to enumerate all objects, regardless of their type.

For the general interaction between UPnP Control Points and UPnP AV devices, further definitions within the UPnP architecture are given in the UPnP AV (audio-visual) Architecture. The current publicly available version is 0.83 for UPnP Version 1.0. Status: Preliminary Design (TPD), date: Jun. 12, 2002, not yet finished. It supports a wide variety of AV devices such as TVs, VCRs, CD/DVD players/jukeboxes, settop boxes, stereo systems, MP3 players, still-image cameras, camcorders, electronic picture frames (EPFs), and the PC. The AV Architecture allows devices to support different types of formats for the entertainment content (such as MPEG2, MPEG4, JPEG, MP3, Windows Media Architecture (WMA), bitmaps (BMP), NTSC, PAL, ATSC, etc.) and multiple types of transfer protocols (such as IEC-61883/IEEE-1394, HTTP GET, RTP, HTTP PUT/POST, TCP/IP, etc.). The document describes the AV Architecture and how the various UPnP AV devices and services work together to enable various end-user scenarios.

A further definition within the AV architecture is given for AV media servers in the document MediaServer:1 Device Template Version 1.01, for Universal Plug and Play Version 1.0, Status: Standardized DCP, date: Jun. 25, 2002. The Media Server template defines a general-purpose device that can be used to instantiate any Consumer Electronic (CE) device that provides AV content (e.g. media) to other UPnP devices on the home network. It exposes its content via the Content Directory Service. As such, the Media Server can handle any specific type of media, any data format, and transfer protocol. Example instances of a Media Server include traditional devices such as VCRs, CD Players, DVD Players, audio-tape players, still-image cameras, camcorders, radios, TV Tuners, and set-top boxes. Additional examples of a Media Server also include new digital devices such as MP3 servers, PVRs, and Home Media Servers such as the PC. Although these devices contain diverse (AV) content in one form or another, the Media Server (via the Content Directory) is able to expose this content to the home network in a uniform and consistent manner. This ability allows the Media Server to instantiate traditional single-function devices as well as more recent multi-function devices such as VCR-DVD players and the general purpose Home Media Server, which contains a wide-variety of content such as MPEG2 video, CD audio, MP3 and/or WMA audio, JPEG images, etc.

CDS is hierarchically organised in a manner similar to a computer file system. A so-called container (analogous to a folder or directory) can include a plurality of objects (analogous to a file) and containers that are hierarchically one level lower. The object includes an object description with an identifier and optionally meta-data. The meta-data may include properties such as object name, artist, composer, date created, size, etc. The object may also include the object content (item) or include a locator, such as a URL, for locating the content. Users can influence the hierarchical structure; it is not prescribed in any way by a standard. New objects may be supplied directly to the device, such as a Media Server, that includes the CDS but may also be supplied through other devices in the system. In the latter case the user usually will interact with that device via a user interface (UI). In principle, the device could enable the user to browse the CDS to determine the most suitable container for the new object. However, limitations on the UI may make this impractical and this puts the burden of organization with the end-user. Consequently, the new object may inadvertently be located in a not very suitable container, undermining a possibly well-designed structure and making retrieval difficult. CDS also makes it possible that a UI device presents CDS content based on the meta-data of the objects. The UI device may create an own hierarchy in the representation based on the metadata, ignoring the actual hierarchy of CDS. If a new object is added purely based on the hierarchy presented by a UI device based on meta-data of objects already present in CDS, ignoring the actual CDS hierarchy, this again may weaken the structure.

It will be appreciated that the media player-like packages can be seen as stand-alone implementations of a CDS supporting a limited range of content and having a user interface for stand-alone interaction. A problem with CDS-like systems is maintaining a well-organized structure. In particular, once the amount of content increases a user may need to browse a large part of the structure to determine the most suitable container to add new content. If the user is not always careful in doing so, content may inadvertently be added to the wrong container. This makes it difficult to locate the content afterwards via a browsing operation. This problem gets even worse if the user accesses the CDS via a network through a device with a possibly limited user interface.

### SUMMARY OF THE INVENTION

It is an object of the invention to provide an improved device, system and method for adding objects to the CDS hierarchy.

To meet the object of the invention, a digital storage device includes a content directory service (hereinafter “CDS”) with a dynamic, hierarchical structure of digital storage containers, each capable of storing digital data objects; each object including an object description and an object content or object content locator, such as a URL; at least one of the containers being a predetermined input container for receiving a digital data object;

the device being arranged to, in response to receiving a digital data object in the predetermined input container, determine a container in the CDS based on the object description and/or object content of the received object, to move the received object to the determined container and to provide feedback to a human operator of the device on the determined container.

In this way the device is responsible for assigning an object to a container in the hierarchy. By using a default container in which a new object is placed, the user knows where to put the objects and the device knows which objects it may re-assign in the CDS hierarchy. By giving feedback to the user, the user can see where the content is located by the device, helping the user in a subsequent retrieval of the data, for example using a browsing operation. In addition, applications can determine that the uploading of their content is successful and can administrate the final location for later use.

According to the measure of the dependent claim 2, the received object is associated with metadata describing the object content, and the device is arranged to determine the container based on the metadata. Using the metadata is a powerful way of determining a suitable container in the hierarchy.

According to the measure of the dependent claim 3, the metadata may be supplied as part of the object description. Alternatively, an identification, such as a CD key, may be supplied that is used by the device to retrieve metadata for the object, e.g. from an external database that couples the identification to the metadata. The metadata may also be embedded in the object content, e.g. in the form of MP3 tags. Instead of deriving the metadata directly or indirectly from the object description or directly from metadata embedded in the object content, the device may also derive the metadata based on the actual object content. For example, the server may produce (or have produced) a fingerprint of the object content and use a database to retrieve metadata corresponding to the fingerprint.

According to the measure of the dependent claim 4, the server performs a verification of the metadata, by deriving metadata from the object description as well as based on the content. Using those two sets of metadata as input, the server can perform a more reliable determination of a container. It can also detect and eliminate errors in the object description, increasing the usability of the CDS.

According to the measure of the dependent claim 5, in the event of a conflict between the two sets of metadata, the device invokes the assistance of a user. It may do this directly using its own user interface or, for example, through the UI of another device.

According to the measure of the dependent claim 6, the device uses rules for determining the container in dependence on metadata. Using a rule set opens many possibilities. For example, the device may enable a human operator to determine and/or modify the rules as defined in the dependent claim 7.

According to the measure of the dependent claim 8, the predetermined container is located in a root of the CDS. This makes finding the container easy.

According to the measure of the dependent claim 9, the device enables a human operator to overrule the container determined by the device. So, if the user sees that the object is automatically moved to a container the user considers unsuitable, the user can choose a different container in which the device then locates the content. In this way, the user can simply add content to the CDS structure (i.e. in the predetermined container), let the device choose the most suitable container, and only if the user disagrees the user may need to browse the structure to find the most suitable location himself. The speed and consistency will thus be increased, while the user keeps full control. Additionally, the system can “learn” from these manual overrides, adapting the rules for determining content locations such that the manual move is consistent with the rules. Here, a minimal adaptation to the rules is searched for. This allows a user to create content structures simply by providing the system with a number of examples.

To meet the object of the invention, a system includes a plurality of devices operative to communicate via a network; at least one of the devices (hereinafter “server”) including a content directory service (CDS) with a dynamic, hierarchical structure of digital storage containers, each capable of storing digital data objects; each object including an object description and an object content or object content locator, such as a URL;

the CDS being accessible by the devices in the network and including a predetermined upload container for uploading an object from a device in the system;

at least one device in the system (hereinafter “uploader”) being arranged to make an object available via the CDS to devices in the system by uploading the object through the network to the predetermined container;

the server being arranged to, in response to receiving an uploaded object in the predetermined upload container, determine a container in the CDS based on the object description and/or object content, to move the uploaded object to the determined container and to provide feedback to the uploader on the determined container. The CDS may notify all clients that have subscribed to being informed of changes to the CDS two times. The first notification may be when the object is added to the default container. The second notification may be of moving the object. By keeping the ID of the moved object the same, clients can determine that the moved object is the object that was previously uploaded, as it disappeared from the default container and appeared in a new place in the structure.

In this way, also for a networked system a fast and consistent CDS is achieved, with the possibility of maintaining flexibility. If the system is based on the CDS as defined for UPnP, no redefinition of any of the mentioned standards is required. The system according to the invention is fully compliant.

In a preferred embodiment as described in the dependent claim 11, the user interface of the uploader is used for providing feedback to the user on where the content is located in the CDS.

The predetermined container may be located in a root of the CDS. This makes finding the container easy (in the sense that only one browse( ) action is needed) for the uploaders.

According to the measure of the dependent claim 13, the CDS includes for each device of the system a respective predetermined container for uploading an object from the respective device. Such a container may be an actual container in the CDS or a logical container giving the uploader the impression that it has full control over the container. An advantage of using separate physical or logical containers is that it reduces the chances of a conflict of multiple uploaders upload objects in an overlapping time interval.

According to the measure of the dependent claim 14, the uploader is able to locate the predetermined container by searching/browsing the CDS. For example, it may search for a container with a predetermined general name, like ‘upload container’, or with a specific name/identifier that links to container to the uploader, like the name or IP address of the uploading device. It is also possible, the close access for write access to all other containers and in this way directing the uploader to the predetermined container.

According to the measure of the dependent claim 15, there can be multiple servers in the system with a CDS; those servers can exchange and/or synchronize the rules for choosing the container. This increases the consistency of the entire system.

These and other aspects of the invention are apparent from and will be elucidated with reference to the embodiments described hereinafter.

### BRIEF DESCRIPTION OF THE DRAWINGS

In the drawings:

FIG. 1 shows an exemplary system;

FIG. 2 shows roles of storing and retrieving content from the CDS;

FIG. 3 shows the hierarchical CDS;

FIG. 4 shows possible structures of an object and location of metadata; and

FIG. 5 shows alternative location for the metadata.

### DETAILED DESCRIPTION OF THE PREFERRED EMBODIMENT

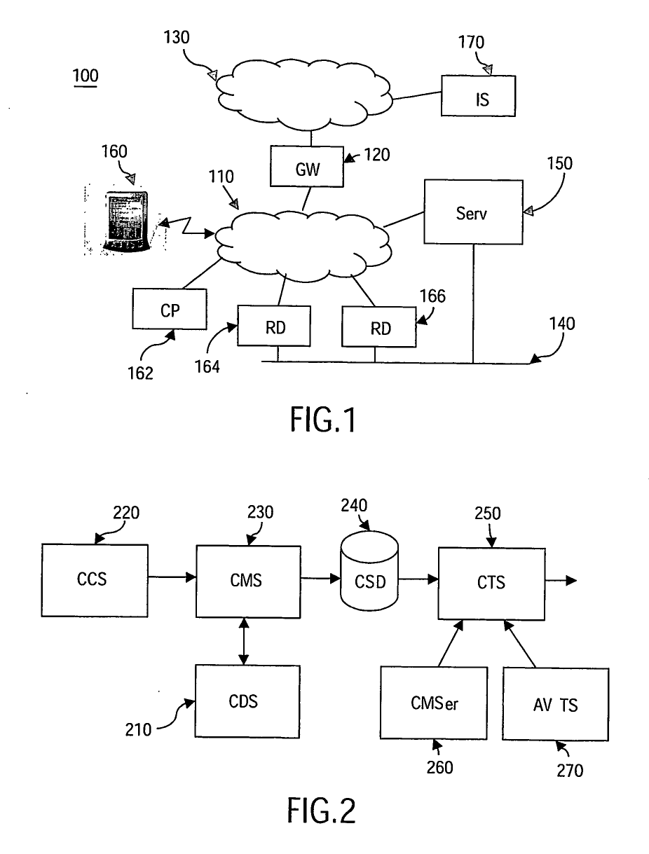

FIG. 1 shows a block diagram of an exemplary system 100 in which the invention may be used. The system includes a network. In the figure a hierarchy of networks is shows. In this example, the main network 110 is a home network that may be based on the UPnP architecture. The description will focus on a UPnP network but it will be appreciated that the same concept can also be applied to non-UPnP system with a network and a CDS-like management of content in the system. It will also be understood that the concept can also be applied to a stand-alone device with a CDS-like hierarchical storage structure that can be controlled by a user. UPnP is based on IP technology and supports many network media and higher level protocols. The media may be wired, e.g. from the Ethernet family of media, or wireless, such as based on IEEE 802.11 family of media. A gateway/router 120 is used to couple the home network 110 to an external network 130, such as the open Internet. The external network may also include devices, such as device 170 that may be an Internet server. A third network 140 may exist for the transfer of, in particular, streaming AV data. Such a network may be based on a technology, like IEEE 1394, that supports isochronous communication. The system includes a plurality of devices that can communicate via the network. A major role is given to the server device 150 that includes a content directory service (hereinafter “CDS”), as will be describe in more detail later on. In principle, more devices may include a CDS. For simplicity only one device with a CDS is shown. The other devices, such as device 160, 162, 164, 166 are able to communicate with each other and/or with the server 150. The devices may have the same or different roles. A device may supply a service to the other devices. An example of such a device is the server 150 that supplies the CDS service. A device, like 160 and 162, may also control other devices. Such a device is called a control point. A device, like the server 150, may supply content to sinks of such content, like the rendering devices 164 and 166. These roles may be freely combined.

Any of the devices may be implemented using conventional hardware and software. For example, the server 150 may be implemented on a personal computer platform, if so desired, with reliable background storage, such as a RAID system or rewritable DVD, for storing the CDS. The server 150 may also be implemented on a Consumer Electronics (CE) device, such as a receiver (e.g. set top box) with integrated hard disk. The rendering devices may be CE devices, such as a TV, audio amplifier, etc. The UI devices may also be CE devices, such as TVs, but may also be hand-held devices such as PDAs, or advanced programmable remote controls, etc. Each of the devices in the system includes the necessary hardware and/or software for communicating with the other devices through the network.

FIG. 2 shows more details on the role of a server, also referred as media server. The server includes the Content Directory Service 210 (CDS). The content is created or captured in a subsystem 220 that may be located in another device. For example, a movie may be received by a tuner or supplied on disk into a DVD player. A photo may be supplied by a digital camera or scanned through a scanner. A content management subsystem 230 ensures that the data object is correctly represented in the CDS. The content management subsystem may but need not be located in the same device as the content creation subsystem 220. The actual content may be stored in the CDS, but may also be stored somewhere else, e.g. in a content storage database 240. Via a content transfer subsystem 250 the content can be supplied to other devices via a communication network. In the UPnP implementation, the media server includes a connection manager service 260 for managing the connection between the source and the sink of the content. The media server may also include a service 270 to manage AV transport.

The Content Directory Service, CDS, provides a set of actions that allow the Control Point to enumerate the content that the Server can provide to the home network. The primary action of this service is Browse( ). This action allows Control Points to obtain detailed information about each Content Item that the Server can provide. This information (i.e. meta-data) includes properties such as its name, artist, date created, size, etc. Additionally, the returned meta-data identifies the transfer protocols and data formats that are supported by the Server for that particular Content Item. The Control Point uses this information to determine if a given Media Renderer is capable of rendering that content in its available format.

Media Server devices are typically used in conjunction with one or more Media Renderer device(s) to allow a Control Point to discover entertainment (AV) content (e.g. video, music, images, etc) on the Media Server and to render that content on any appropriate Media Renderer within the home network. In general terms, the process begins with the Control Points discovering Media Server and Media Renderer devices within the home network. The Control Point interacts with a Media Server(s) to locate a desired piece of content (e.g. a movie, a song, a playlist, a photo album, etc). Typically, the user interacts with the user interface (UI) of the Control Point to locate and select the desired content on the Media Server and to select the target Media Renderer. The Media Server contains or has access to a variety of entertainment content, either stored locally or stored on an external device that is accessible via the Media Server. The Media Server is able to access its content and transmit it to another device via the network using some type of transfer protocol. The content exposed by the Media Server may include arbitrary types of content including video, audio, and/or still images. The content is transmitted over the network using a transfer protocol and data format that is understood by the Media Server and Media Renderer. Examples of a Media Server include a VCR, CD/DVD player/jukebox, camera, camcorder, PC, set-top box, satellite receiver, audio tape player, etc.

A Media Server device may provide clients with the following capabilities:
Enumerate and query any of the content that the Media Server can provide to the home network.
Negotiate a common transfer protocol and data format between the Media Server and target device.
Control the flow of the content (e.g. FF, REW, etc).
Copy (import) content to the Media Server from another device.

In general terms, the process begins with the Control Points discovering Media Server and Media Renderer devices within the home network. The Control Point interacts with a Media Server(s) to locate a desired piece of content (e.g. a movie, a song, a playlist, a photo album, etc). After the content has been identified, the Control point needs to identify a common transfer protocol and data format that can be used to transfer the content from the Media Server to the desired Media Renderer. After these transfer parameters have been established, the Control Point controls the flow of the content (e.g. Play, Pause, Stop, Seek, etc.). Control Points use the Media Server's Content Directory Service to locate desired content. The CDS exposes both a search capability and a browse capability. Searching is useful when the Control Point (via the end-user) knows something about the content it wants to find (e.g. its name, artist, type, date created, etc). Browsing is useful for blindly discovering what content the device has to offer. Each content item that is referenced by the CDS includes various information about that content including the transfer protocol(s) and file format(s) that the Media Server can use to transfer the content to the Media Renderer. The invention deals with copying or moving content from a device to the CDS.

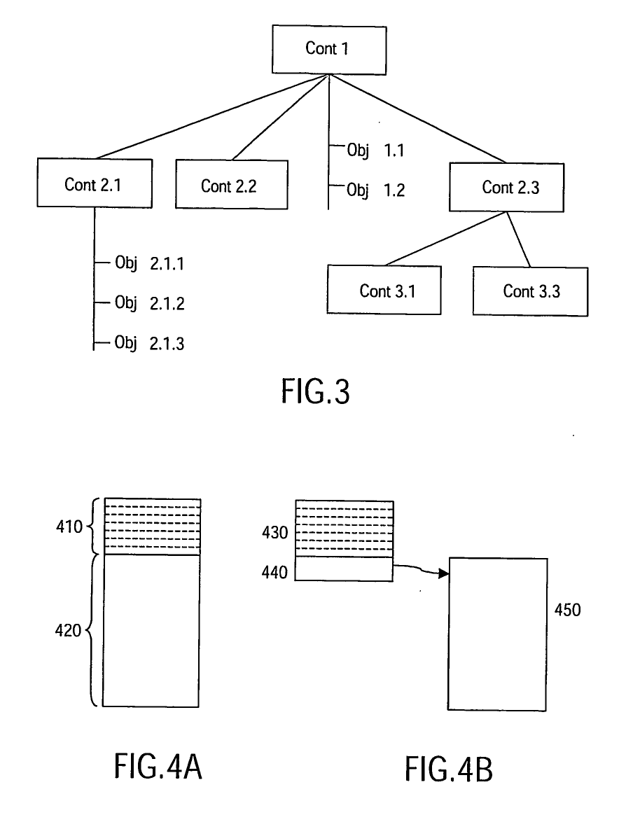

The Content Directory Service includes a hierarchical structure of containers. Such container can be seen as equivalent to folders/directories in a file system. In principle a container may also be physically represented as a file/directory. It may also be represented differently, e.g. the entire CDS may be one file with an internal structure that makes identification of and access to containers/objects possible. FIG. 3 shows an example of a hierarchical structure with six containers Cont 1, Cont 2.1, Cont 2.2, Cont 2.3, Cont 3.1 and Cont 3.3. The exemplary CDS at that moment contains three hierarchical layers, layer 1 with Cont 1, layer 2 with Cont 2.1, Cont 2.2, and Cont 2.3, layer 3 with Cont 3.1 and Cont 3.3. The top container (cont 1) is also referred to as root. Preferably, each container can also include objects, in particular but not limited to AV content, such as an audio title, movie, photographs, etc. The system can also work if, for example, only the lowest layer of containers can include objects. In the example of FIG. 3, Cont 1 includes two objects Obj 1.1 and 1.2; and container Cont 2.1 includes there objects Obj 2.1, Obj 2.2, and Obj 2.3. In principle, the CDS is dynamic, in the sense that a user can determine the containers in the CDS and the hierarchy among the containers.

Each object includes an object description. The description may include several fields, like an identifier, such as a name. In particular, it is preferred that the content description includes metadata describing the content. For example, for an audio title such metadata may include the name of a singer, composer and producer, and recording data, such a recording company, studio, etc. In addition to the content description, the object also includes actual content, such as an MP3 file. This is shown in FIG. 4A where the object includes an object description 410 and object content 420. Instead of containing the actual content, the object may in fact include an object content locator 440, such as a URL, that enables locating the actual content 450. In principle, the content description may also refer to some of the fields to another location, e.g. a server on the Internet.

According to the invention, the CDS includes a predetermined upload container for uploading an object from a device in the system. A device in the system then uploads an object to that container. The server then determines for the uploaded object a suitable container in the CDS and moves the uploaded object to the determined container. The CDS may automatically detect that an object is uploaded and then perform the move operation, or may perform the move operation after having been instructed by the uploading device. Such an instruction may implicitly have effect for all possible objects in the container, or the uploading device may explicitly indicate which object to re-assign in the CDS. It is preferred that the CDS automatically detects that an object is placed in the predetermined container and then performs the re-assignment without any further involvement of the uploading device or a human operator. It will be appreciated that the fact that the CDS includes a predetermined container for the uploading device does not necessarily restrict the uploading device in not being able to access or upload to the others parts of the CDS. According to the invention, the CDS automatically determines the most suitable container based on the object description and/or object content. Feedback is provided on where the content is placed in the CDS. For example, if a user directly operates on the CDS though the user interface of the device containing the CCS, it is preferred that the feedback also takes place via this interface. The feedback may include showing a graphical representation of a relevant part of the CDS structure that includes the selected container. The representation may be list based, icon-based, or using any other suitable form. If the CDS is operated via a different uploading device (control point in UPnP terminology), preferably, the CDS provides feedback to the uploading device so that the uploading device can use its own UI to inform the user about the chosen container. Advantageously, the system enables a user to overrule the choice made by the CDS. For example, the user may decide to perform a browsing operation through the CDS, locate another container and instruct the CDS to move the object to that container.

In a preferred embodiment, the re-assignment is based on metadata describing the object content. The server has knowledge of metadata of containers and objects already in the CDS. Based on this knowledge, it determines a most suitable container. The CDS may do this by comparing the metadata of the object to metadata of the present containers (and/or objects in the containers) and place it in the most likely container. A weighing mechanism may be used for weighing the metadata fields. If the outcome of such a comparison is that presently available containers give a match below a certain threshold, then the CDS may place the object in a temporary container. A human operator may then need to assist in making the final assignment.

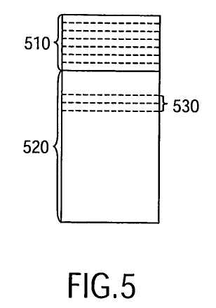

The server may retrieve the metadata directly from the content description or via a pointer from a different location. Alternatively, the object description may include an object content identifier (such as a CD identifier). In this case, preferably, the server retrieves the metadata in dependence on the object content identifier. For example, the server accesses a different server on the open Internet that contains a database providing metadata, such as artist name, for the CD identifier. Alternatively, the metadata may be embedded in the object content, as is illustrated in FIG. 5. For example, an MP3 coded audio title includes metadata data as tags in the content. FIG. 5 shows the object description 510, the object content 520 and the embedded metadata 530 in the content 520. If the metadata is not available in any direct way, like the ways described above, the server preferably takes measures to determine the metadata based on the real content. To this end, preferably the server determines (or uses another device to determine) a fingerprint of the actual object content and retrieves the metadata in dependence on the fingerprint. Fingerprinting techniques are known. It is also known to use a database to produce metadata that corresponds to the fingerprinted content.

As will be understood, the server may obtain metadata in several ways, e.g. from the object description, embedded in the object content or through fingerprinting. Preferably, the server uses several of such sources, if readily available, to improve the assignment. For example, the metadata of the several sources may be complementary and improve the quality of the assignment. If so available, the server compares the metadata of the several sources. If the comparison reveals a mismatch (e.g. different artist names, title names, etc.), preferably the server is arranged to interact with a human operator.

The automatic assignment is preferably based on rules that govern the mapping of the metadata to the containers. For example, a rule could be to place all audio titles in or hierarchically below the container “my music”. A further rule could be to place the audio titles in sub-containers based on artist name. As an alternative rule, a user could have defined that the sub-containers are arranged on music genre, such as rock-and-roll, classic, house, etc. It is well-known how to design rule-based systems. Preferably, the user can easily define and modify the rules. Advantageously, the CDS automatically adapts its rules for assigning an object to a container each time the user overrules a container chosen by the CDS.

The system may include more than one server each including respective rules for determining a container in the CDS in dependence on metadata. If so, preferably the servers are operative to exchange and/or synchronize the rules. If so desired, one server may be assigned as the main server containing a rule database also used by the other servers.

The predetermined container is preferably located at an easy locatable place in the CDS. Preferably, the container is directly located under the root. Also other fixed or unique identified locations may be used (e.g. using agreed names for the container(s)).

Preferably, the CDS includes for each device of the system a respective predetermined container for uploading an object from the respective device. This may be an actual container in the CDS or a logical container, in the sense that the uploading device is let to believe (via the defined ways of accessing the CDS) that such a special container exists for it whereas it actually does not exist (e.g. it is not visible to other devices). Such containers may, for example, be identified using IP addresses or other suitable identifiers.

For the UPnP versions of a CDS, the standards referred to in the introduction include all functionality for interaction between an uploading device and the CDS as required for the invention. Functions that may be used include Browse, CreateObject, DestroyObject, and UpdateObject.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in a claim. The invention can be implemented by means of hardware comprising several distinct elements, and by means of a suitably programmed computer. Where the system/device/apparatus claims enumerate several means, several of these means can be embodied by one and the same item of hardware. The computer program product may be stored/distributed on a suitable medium, such as optical storage, but may also be distributed in other forms, such as being distributed via the Internet or wireless telecommunication systems.

1. A digital storage device including a content directory service (CDS) with a dynamic, hierarchical structure of digital storage containers, each capable of storing digital data objects; each object including an object description and an object content or object content locator, such as a URL; at least one of the containers being a predetermined input container for receiving a digital data object;
in response to receiving a digital data object in the predetermined input container, the device being arranged to determine a container in the CDS based on the object description and/or object content of the received object, to move the received object to the determined container and to provide feedback to a human operator of the device on the determined container.

2. A device as claimed in claim 1, wherein the received object is associated with metadata describing the object content, and the device being arranged to determine the container based on the metadata associated with the received object.

3. A device as claimed in claim 2, wherein the metadata is made available to the device in at least one of the following ways:
the object description includes the metadata;
the object description includes an object content identifier and the device being arranged to retrieve the metadata in dependence on the object content identifier;
the metadata is embedded in the object content;
the device being arranged to determine a fingerprint of the object content and to retrieve the metadata in dependence on the fingerprint.

4. A device as claimed in claim 2, wherein the metadata is included in the object description or retrieved using the object description; the device being arranged to determine a fingerprint of the object content, to retrieve further metadata in dependence on the fingerprint and to compare the metadata and the further metadata.

5. A device as claimed in claim 4, wherein the device is arranged to interact with a human operator if the comparison reveals a mismatch.

6. A device as claimed in claim 2, wherein the device includes rules for determining the container in dependence on metadata.

7. A device as claimed in claim 6, wherein the device is operative to enable a human operator to determine and/or modify the rules.

8. A device as claimed in claim 1, wherein the predetermined container is located in a root of the CDS.

9. A device as claimed in claim 1, wherein the device is operative to enable the human operator to overrule the container determined by the device.

10. A system including a plurality of devices operative to communicate via a network; at least one of the devices (server) including a content directory service (CDS) with a dynamic, hierarchical structure of digital storage containers, each capable of storing digital data objects; each object including an object description and an object content or object content locator, such as a URL;
the CDS being accessible by the devices in the network and including a predetermined upload container for uploading an object from a device in the system;
at least one device in the system (uploader) being arranged to make an object available via the CDS to devices in the system by uploading the object through the network to the predetermined container;
the server being arranged to, in response to receiving an uploaded object in the predetermined upload container, determine a container in the CDS based on the object description and/or object content, to move the uploaded object to the determined container and to provide feedback to the uploader on the determined container.

11. A system as claimed in claim 10, wherein the uploader is operative to provide feedback to a human operator of the device on the determined container.

12. A system as claimed in claim 10, wherein the uploaded object is associated with metadata describing the object content, and the server being arranged to determine the container based on the metadata associated with the uploaded object.

13. A system as claimed in claim 10, wherein the CDS includes for each device of the system a respective predetermined upload container for uploading an object from the respective device.

14. A system as claimed in claim 10, wherein the uploader is operative determine the predetermined upload container by searching the CDS.

15. A system as claimed in claim 10, wherein the uploaded object is associated with metadata describing the object content, the system includes a plurality of servers each including respective rules for determining a container in the CDS for an uploaded object in dependence on metadata associated with the uploaded object; the servers being operative to exchange and/or synchronize the rules.

16. A method of assigning a digital data object to a digital storage container in a content directory service (CDS) with a dynamic, hierarchical structure of digital storage containers, each capable of storing digital data objects, and each digital data object including an object description and an object content or object content locator, such as a URL; at least one of the containers being a predetermined input container for receiving a digital data object; the method including:
detecting that a digital data object has been received in the predetermined input container;
in response to such detection, determining a container in the CDS based on the object description and/or object content of the received object, moving the received object to the determined container; and providing feedback to a human operator on the determined container.

17. A computer program product operative to cause a processor to perform the method as claimed in claim 16.
